(19) United States
(12) Patent Application Publication
(10) Pub. No.: US 2009/0033842 A1
(43) Pub. Date: Feb. 5, 2009

(54) Display panel and method for manufacturing the same

(75) Inventors: Se Hwan Yu, Asan-Si (KR); Hyang Shik Kong, Seongnam-Si (KR); Eun Guk Lee, Yongin-Si (KR); Kyung Sook Jeon, Bupyeong-Gu (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/072,684

(22) Filed: Feb. 26, 2008

(30) Foreign Application Priority Data
Aug. 3, 2007 (KR) 10-2007-0078253

(51) Int. Cl. G02F 1/1335; G02F 1/1333

(52) U.S. Cl. 349/106; 349/187

(57) ABSTRACT

A display panel and a method for manufacturing the same are provided. A blue color filter and a first light shielding pattern are simultaneously formed on top of a substrate through a photolithography process using a blue photoresist layer. Light shielding columns functioning as column spacers are formed above thin film transistors to prevent light leakage through the thin film transistors.

This application claims priority to Korean Patent application No. 10-2007-0078253, filed on Aug. 3, 2007 and all the benefits accruing therefrom under 35 U.S.C. 119, the contents of which are herein incorporated by reference in its entirety.

### BACKGROUND OF THE INVENTION

1. Field of the Invention

The present invention relates to a display panel having color filters and thin film transistors sequentially formed on a single substrate and a method for manufacturing the display panel, and more particularly, to a display panel and a method for manufacturing the same capable of simplifying a manufacturing process of a light shielding pattern for preventing light leakage and mixture of colors between color filters to thereby reduce manufacturing costs.

2. Description of the Related Art

In general, a thin film transistor-liquid crystal display (TFT-LCD) panel includes a lower substrate with pixel electrodes, thin film transistors (“TFT”s) and the like formed thereon, an upper substrate with a light shielding pattern, a common electrode, color filters and the like formed thereon, and liquid crystals sealed between the two substrates. To manufacture such a conventional liquid crystal display (“LCD”) panel, the corresponding elements are formed on the lower and upper substrates. Subsequently, the lower and upper substrates are bonded together. Then, liquid crystals are inserted between the two substrates previously bonded together. When the lower and upper substrates are bonded together, misalignment may occur between the two substrates. Therefore, misalignment occurs between pixel electrodes of the lower substrate and color filters of the upper substrate, so that desirable images may not be displayed on the display panel.

Recently, red, green and blue color filters are first formed on a surface of a lower substrate, and then TFTs and pixel electrodes are formed thereon. Accordingly, a display panel defect caused by the aforementioned misalignment between the two substrates can be prevented. However, in order to form the color filters on the surface of the lower substrate, a first light-shielding pattern for preventing light leakage and mixture of colors between the color filters is formed ahead of the formation of the color filters. Additionally, a second light shielding pattern for preventing light leakage through TFTs is formed on the TFTs after manufacturing the TFTs. Since a process of forming a light shielding pattern is performed twice in such a manner, a process of manufacturing a display panel becomes complicated. Further, since the same process is repeatedly performed, the productivity of the display panel is lowered.

### SUMMARY OF THE INVENTION

An aspect of the present invention provides a display panel and a method for manufacturing the same, wherein a separate manufacturing process of a lower light shielding pattern can be omitted by using a blue color filter to manufacture the lower light shielding pattern, and a manufacturing process of an upper light shielding pattern can be omitted by using a light shielding column for shielding light and maintaining a cell gap.

Another aspect of the present invention provides a display panel and a method for manufacturing the same capable of enhancing productivity and reducing manufacturing costs by simplifying process.

According to an aspect of the present invention, there is provided a method for manufacturing a display panel, including: forming a first light shielding pattern in a boundary region of blue, red and green pixel regions on a substrate using a blue photoresist layer, and forming a blue color filter in the blue pixel region; forming red and green color filters in the red and green pixel regions, respectively; forming a plurality of gate and data lines on the first light shielding pattern, and forming a plurality of thin film transistors (TFTs) respectively connected to the gate and data lines; forming a protective layer on an entire surface of the substrate; and forming pixel electrodes connected to the corresponding TFTs on the protective layer of the blue, red and green pixel regions, respectively.

Forming the first light shielding pattern and the blue color filter may include coating the substrate with a blue photoresist layer; exposing the blue photoresist layer using a mask; and developing the exposed blue photoresist layer, and removing the blue photoresist layer in the red and green pixel regions.

The red and green color filters may be formed by an inkjet printing method.

The height of the blue color filter may be highest, and the height of the red color filter may be lowest.

The height of the blue color filter may be higher by 750 to 1250 Å than that of the green color filter, and the height of the red color filter may be lower by 750 to 1250 Å than that of the green color filter.

The line width of the first light shielding pattern may be 101 to 130% of that of the gate and/or data line.

After forming the plurality of TFTs, the method may further include forming a second light shielding pattern on top of the plurality of TFTs.

After forming the plurality of TFTs, the method may further include: forming a passivation layer on top of the entire structure of the substrate; and forming a second light shielding pattern on the passivation layer in regions above the plurality of TFTs.

The second light shielding pattern may also be formed in a peripheral area of the substrate.

After forming the pixel electrodes, the method may further include forming light shielding columns in regions above the plurality of TFTs.

The light shielding columns may be further formed in a peripheral area of the substrate.

Forming the light shielding columns may include: coating the entire structure of the substrate with a non-transparent organic layer; and exposing and developing the non-transparent organic layer using a slit mask or a half-tone mask, and removing the non-transparent organic layer of a region except the regions above the plurality of TFTs.

According to another aspect of the present invention, there is provided a method for manufacturing a display panel, including: forming a first light shielding pattern in a boundary region of blue, red and green pixel regions on an upper substrate using a blue photoresist layer, and forming a blue color filter in the blue pixel region; forming red and green color filters in red and green pixel regions, respectively; and forming a common electrode on top of the upper substrate having the color filters formed thereon.

The first light shielding pattern and the blue color filter may be formed through an exposure and development process using the blue photoresist layer, and the red and green color filters may be formed by an inkjet printing method.

The height of the blue color filter may be highest, and the height of the red color filter may be lowest.

The method may further include: providing a lower substrate having TFTs, gate lines, data lines and pixel electrodes formed thereon; and bonding and sealing the upper substrate having the common electrode formed thereon and the lower substrate, wherein the line width of the first light shielding pattern is 101 to 130% of that of the gate and/or data line.

Before forming the common electrode, the method may further include forming a second light shielding pattern on a region of the upper substrate corresponding to the TFTs.

After forming the common electrode, the method may further include forming light shielding columns on a region of the upper substrate corresponding to the TFTs.

According to a further aspect of the present invention, there is provided a display panel, including: a lower substrate having a plurality of blue, red and green pixel regions defined therein; a first light shielding pattern formed in a boundary region of the plurality of blue, red and green pixel regions on top of the lower substrate using a blue photoresist layer, and a plurality of blue color filters formed in the plurality of blue pixel regions; a plurality of red and green color filters formed in the plurality of red and green pixel regions, respectively; a plurality of gate and data lines formed on the first light shielding pattern; a plurality of TFTs connected to the plurality of gate and data lines, respectively; a plurality of pixel electrodes formed in the plurality of blue, red and green pixel regions and connected to the corresponding TFTs, respectively; an upper substrate having a common electrode, the upper substrate being spaced apart from the lower substrate so that the common electrode faces the pixel electrodes; and a liquid crystal layer interposed between the upper and lower substrates.

The blue color filter and the first light shielding pattern may be formed through an exposure and development process using the blue photoresist layer, and the red and green color filters may be formed by an inkjet printing method.

The height of the blue color filter may be highest, and the height of the red color filter may be lowest.

The line width of the first light shielding pattern may be 101 to 130% of that of the gate and/or data line.

The display panel may further include a second light shielding pattern formed on top of the plurality of the TFTs.

The display panel may further include light shielding columns formed between the lower and upper substrates.

The light shielding columns may be formed of an organic material with light transmittance of 10% or less and formed on top of the plurality of the TFTs.

### BRIEF DESCRIPTION OF THE DRAWINGS

Preferred embodiments of the present invention can be understood in more detail from the following description taken in conjunction with the accompanying drawings, in which:

FIGS. 1A to 6A are plan views illustrating a method for manufacturing a display panel according to an exemplary embodiment of the present invention;

FIGS. 1B to 6B and 7 are cross-sectional views illustrating the method for manufacturing the display panel according to the exemplary embodiment of the present invention;

FIGS. 8A to 11A are plan views illustrating a method for manufacturing a display panel according to another exemplary embodiment of the present invention; and

FIGS. 8B to 11B are cross-sectional views illustrating the method for manufacturing the display panel according to the exemplary embodiment of the present invention.

### DESCRIPTION OF THE PREFERRED EMBODIMENT

Hereinafter, exemplary embodiments of the present invention are described in detail with reference to the accompanying drawings. However, the present invention is not limited to the embodiments disclosed below but may be implemented into different forms. These embodiments are provided only for illustrative purposes and for full understanding of the scope of the present invention by those skilled in the art.

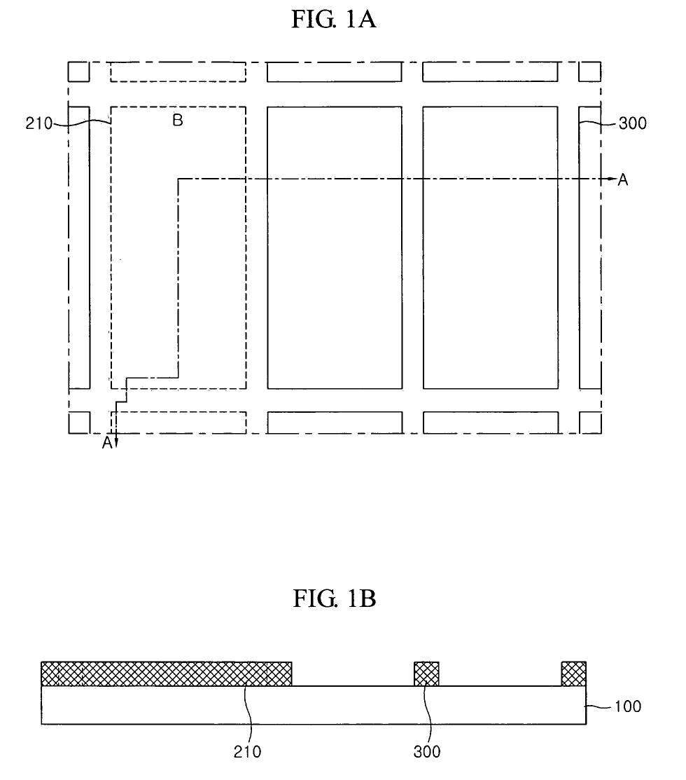

FIGS. 1A to 6A are plan views illustrating a method for manufacturing a display panel according to an exemplary embodiment of the present invention, and FIGS. 1B to 6B and 7 are sectional views illustrating the method for manufacturing a display panel according to the exemplary embodiment of the present invention.

Referring to FIGS. 1A and 1B, a blue color filter 210 and a first light shielding pattern 300 are formed on a lower substrate 100.

That is, an entire surface of the lower substrate 100 is coated with a blue photoresist layer. Alternatively, the photoresist layer could be a color other than blue, such as, for example, red or green when the color display uses red, green and blue color filters. The blue photoresist layer is coated onto the entire surface of the lower substrate 100 through a spinning process. In the spinning process, a photoresist solution is dropped onto and coated on the lower substrate 100. Alternatively, a slitting process may be used to coat the blue photoresist layer. In the slitting process, the photoresist solution is uniformly applied to the lower substrate 100. Subsequently, the blue photoresist layer is exposed using a mask, and then developed. Thereafter, the developed blue photoresist layer is cured to thereby form the blue color filter 210 and the first light shielding pattern 300. An organic layer containing a blue pigment may be used as the blue photoresist layer. Here, a transparent glass substrate is used as the lower substrate 100. It will be apparent that a transmissive plastic or acryl substrate may be used as the lower substrate 100. The lower substrate 100 is divided into a light transmitting area provided with pixels for displaying an image and a peripheral area. Each of the pixels in the light transmitting area has a light transmitting region and a pixel separating region (i.e., a light shielding region).

The first light shielding pattern 300 prevents light leakage through gate and data lines 410 and 440 formed on top of the first light shielding pattern 300 through a subsequent process, and prevents the mixture of colors between red and green color filters 220 and 230 formed through a subsequent process.

Here, the first light shielding pattern 300 include a first line extending in a direction of the gate line 410, and a second line extending in a direction of the data line 440. The first and second lines intersect each other. Accordingly, the first light shielding pattern 300 is formed in a shape of a mesh, and provided in the pixel separating region to define the light transmitting region of the pixel. The line width of the first and second lines in the first light shielding pattern 300 may be broader than that of the gate and data lines 410 and 440. It will be apparent that the line width of the first and second lines may be similar to that of the gate and data lines 410 and 440. When the line widths of the gate and/or data lines 410 and/or 440 is 100, the line width of the first and second lines may be 101 to 130.

The first light shielding pattern 300 functions as a barrier for preventing the mixture of colors between color filters in the light transmitting regions of the pixel. That is, the first light shielding pattern 300 is formed in a shape surrounding the light transmitting region of the pixel, thereby preventing the red and green color filters, which is formed through a subsequent process, from being out of the light transmitting regions of the pixels. At this time, the thickness of the first light shielding pattern 300 (i.e., the thickness from a surface of the lower substrate 100) is greater than that of the red and green color filters 220 and 230. Here, the blue color filter 210 is formed simultaneously with the first light shielding pattern 300 in the light transmitting region of the blue pixel as shown in FIGS. 1A and 1B.

As such, in this embodiment, the blue photoresist layer is used as the blue color filter 210 and the first light shielding pattern 300, so that the process can be simplified. That is, the process of forming a first light shielding pattern using an additional material, such as a black matrix, may be omitted by the manufacturing method according to this embodiment. Accordingly, the manufacturing costs can be reduced, as well as the process for manufacturing the display panel can be simplified. The transmittance (13%) of the blue photoresist layer is lower than the transmittance (24%) of a red photoresist layer and the transmittance (58%) of a green photoresist layer. Hence, the blue photoresist layer is used to form the first light shielding pattern 300. Although not shown in the figures, the first light shielding pattern 300 may be provided in the peripheral area of the lower substrate 100.

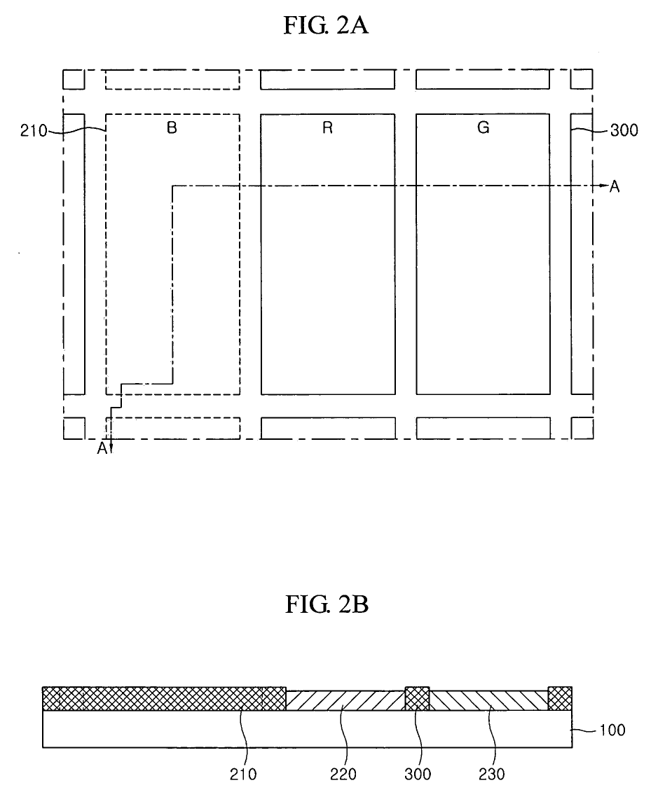

Referring to FIGS. 2A and 2B, red and green color filters 220 and 230 are formed in the light transmitting regions of the red and green pixels defined by the first light shielding pattern 300, respectively.

The red and green color filters 220 and 230 may be formed by an inkjet printing method. Here, red and green color filter solutions are injected into the light transmitting regions of the red and green pixels defined by the first light shielding pattern 300, respectively. Subsequently, the solutions are uniformly distributed in the light transmitting regions of the pixels. Then, the red and green color filters 220 and 230 are formed by curing the solutions. At this time, the red and green color filter solutions are injected into the light transmitting regions of the pixels through injection heads, respectively. The red and green color filter solutions may be injected simultaneously or individually. Each of the red and green color filter solutions injected into the light transmitting regions of the pixels can be positioned in the light transmitting region of the corresponding pixel by the first light shielding pattern 300 provided at an outer portion of the light transmitting region of the corresponding pixel. The red and green color filter solutions may be simultaneously injected in this embodiment, which can simplify the process.

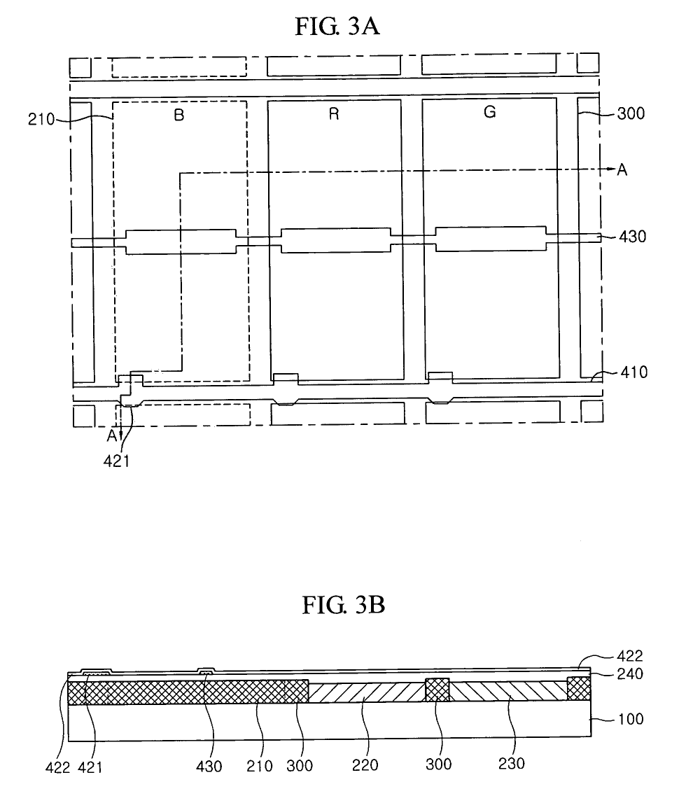

Referring to FIGS. 3A and 3B, an overcoat layer 240 is formed on the entire surface of the lower substrate 100 having the blue, red and green color filters 210, 220 and 230, respectively, and the first light shielding pattern 300. A transparent organic layer is used as the overcoat layer 240. That is, the entire surface of the lower substrate 100 is coated with the transparent organic layer. The overcoat layer 240 is formed by curing the transparent organic layer.

Thereafter, the gate lines 410, gate electrodes 421 and storage lines 430 are formed on the overcoat layer 240.

To this end, a first conductive layer is first formed on the overcoat layer 240 through a deposition method, such as CVD, PVD, sputtering or the like. The first conductive layer may be formed of one of Al, Nd, Ag, Cr, Ti, Ta, Mo and combinations thereof or an alloy including at least one of the forgoing elements. The first conductive layer may be formed to have a single- or multi-layered structure. In other words, the first conductive layer may be formed to have a double- or triple-layered structure including a metal layer having superior chemical and physical properties such as Cr, Ti, Ta, Mo or the like, and another metal layer having low specific resistivity such as an Al- or Ag-based metal layer. Subsequently, the first conductive layer is coated with a photoresist layer. A first photoresist mask pattern is formed on the first conductive layer through an exposure and development process using a mask. An etching process is performed using the first photoresist mask pattern as an etching mask to remove a portion of the first conductive layer. Accordingly, the gate lines 410, the gate electrodes 421 and the storage lines 430 are formed as shown in FIGS. 3A and 3B.

The gate line 410 extends in a horizontal direction as shown in FIG. 3A. As described above, the gate line 410 is positioned on the first line of the first light shielding pattern 300. Further, the gate line 410 partially protrudes to form the gate electrode 421. The storage line 430 extends in the same direction as the gate line 410 and passes through the light transmitting regions of the pixels. Subsequently, a predetermined stripping process is performed to remove the first photoresist mask pattern.

A gate insulating layer 422 is formed on the entire surface of the lower substrate 100 having the gate lines 410, the gate electrodes 421 and the storage lines 430 formed thereon. That is, the gate insulating layer 422 is formed on the entire surface of the lower substrate 100 through a deposition method including PECVD, sputtering or the like. The gate insulating layer 422 is formed of an inorganic insulating material including silicon oxide or silicon nitride. The gate insulating layer 422 can be formed of a dielectric organic material having a low dielectric constant.

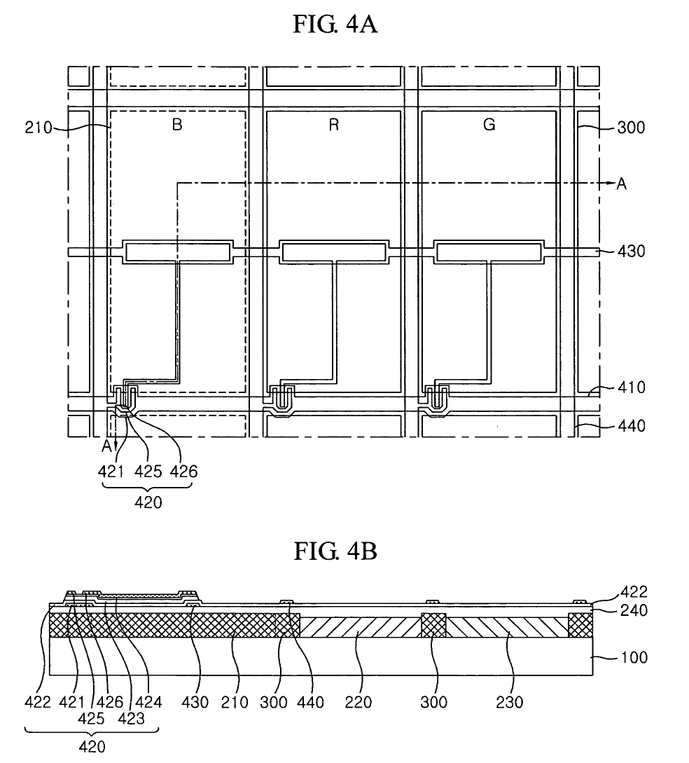

Referring to FIGS. 4A and 4B, the data lines 440 and thin film transistors (“TFT”s) 420, each of which has a gate electrode 421, a source electrode 425 and the drain electrode 426, are formed on the gate insulating layer 422.

To this end, a thin film for an active layer, a thin film for an ohmic contact layer and a second conductive layer are sequentially formed on the gate insulating layer 422. An amorphous silicon layer is used as the thin film for an active layer. A silicide or amorphous silicon layer highly doped with N-type impurities is used as the thin film for an ohmic contact layer. The same material as the first conductive layer may be used as the second conductive layer

Subsequently, the second conductive layer is coated with a photoresist layer. The photoresist layer is exposed and developed using a slit mask. Accordingly, a second photoresist pattern with a stepped pattern is formed. Thereafter, the second conductive layer, the thin film for an ohmic contact layer and the thin film for an active layer are removed through a first etching process using the second photoresist pattern as an etching mask, in order to form the data lines 440 and an active layer 423. Then, a portion of the second photoresist pattern is removed, so that a stepped pattern region is opened. Subsequently, the second conductive layer and the thin film for an ohmic contact layer in the opened region are removed, to form the source and drain electrodes 425 and 426. An ohmic contact layer 424 is formed between the source and drain electrodes 425 and 426, and the active layer 423. Accordingly, a TFT having gate, source and drain electrodes 421, 425 and 426, is manufactured. Here, the source electrode 425 is connected to the data line 440. The drain electrode 426 extends inwardly to the light transmitting region of each pixel and partially overlaps with a portion of the storage line 430. Here, the active layer 423 and the ohmic contact layer 424 may be provided under the data line 440. The active layer 423 and the ohmic contact layer 424, which are provided under the data line 440, may have the same planar shape as the data line 440.

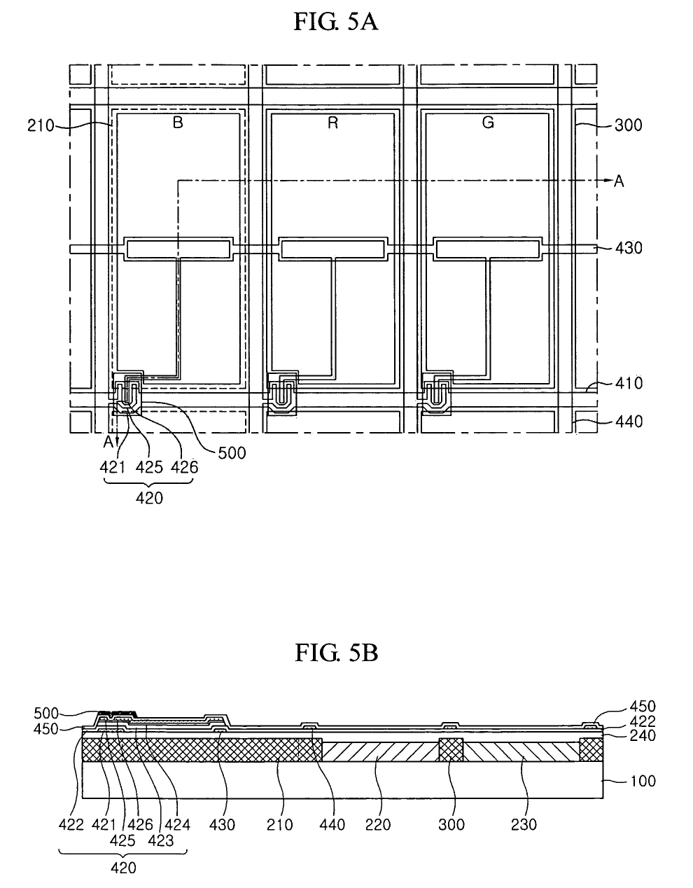

Referring to FIGS. 5A and 5B, a passivation layer 450 is formed on the entire surface of the lower substrate 100 having the data lines 440 and the TFTs 420 thereon. The passivation layer 450 is formed on the entire surface of the lower substrate 100 through a deposition method including PECVD, sputtering or the like. A silicon nitride layer may be used as the passivation layer 450. Of course, the present invention is not limited thereto. That is, the passivation layer 450 may be formed of an inorganic insulating material including silicon oxide.

Thereafter, a second light shielding pattern 500 is formed on the passivation layer 450 above the TFTs 420. That is, a light shielding layer is formed on the passivation layer 450. The light shielding layer in a region except the regions above the TFTs 420 is removed through a patterning process, and then the second light shielding pattern 500 is formed. A black matrix may be used as the light shielding layer. Of course, the present invention is not limited thereto. That is, an organic or inorganic material layer having light transmittance of 10% or less may be used as the light shielding layer.

As such, in this exemplary embodiment, light leakage through the TFTs 420 can be prevented by forming the second light shielding pattern 500 in the regions above the TFTs 420. Further, the second light shielding pattern 500 is also provided in the peripheral area of the lower substrate 100. Accordingly, light leakage in the peripheral area can be prevented.

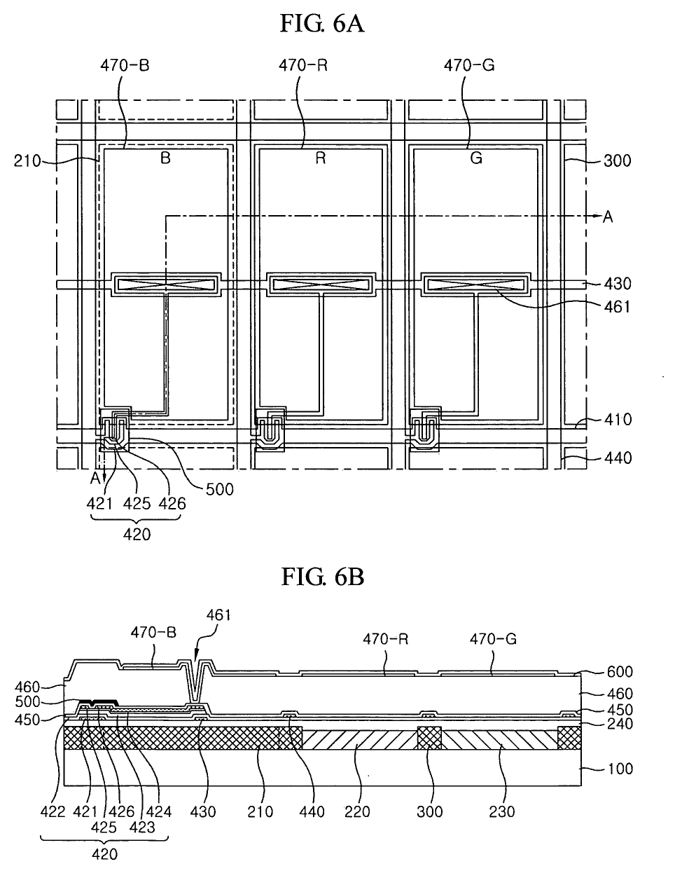

Referring to FIGS. 6A and 6B, a protective layer 460 is formed on an entire surface of the passivation layer 450 having the second light shielding pattern 500 thereon. Contact holes 461 for partially exposing the drain electrodes 426 of the TFTs 420 are formed by removing portions of the protective layer 460 and the passivation layer 450 through an etching process using a third photoresist mask.

Subsequently, a third conductive layer is formed on the protective layer 460 having contact holes 461 thereon. The third conductive layer is coated with a photoresist layer. Then, an exposure and development process is performed using a mask, and a fourth photoresist mask pattern is formed on the third conductive layer. Then, pixel electrodes 470 (470-B, 470-R and 470-G) are formed by removing a portion of the third conductive layer through an etching process using the fourth photoresist mask pattern as an etching mask. The pixel electrodes are connected to the TFTs 420 through the contact holes 461, respectively. The pixel electrodes 470 are provided in the light transmitting regions of the pixels, respectively. A transparent conductive layer including indium tin oxide (ITO) or indium zinc oxide (IZO) is used as the third conductive layer.

Thereafter, a lower alignment layer is formed on top of the entire structure of the TFT substrate.

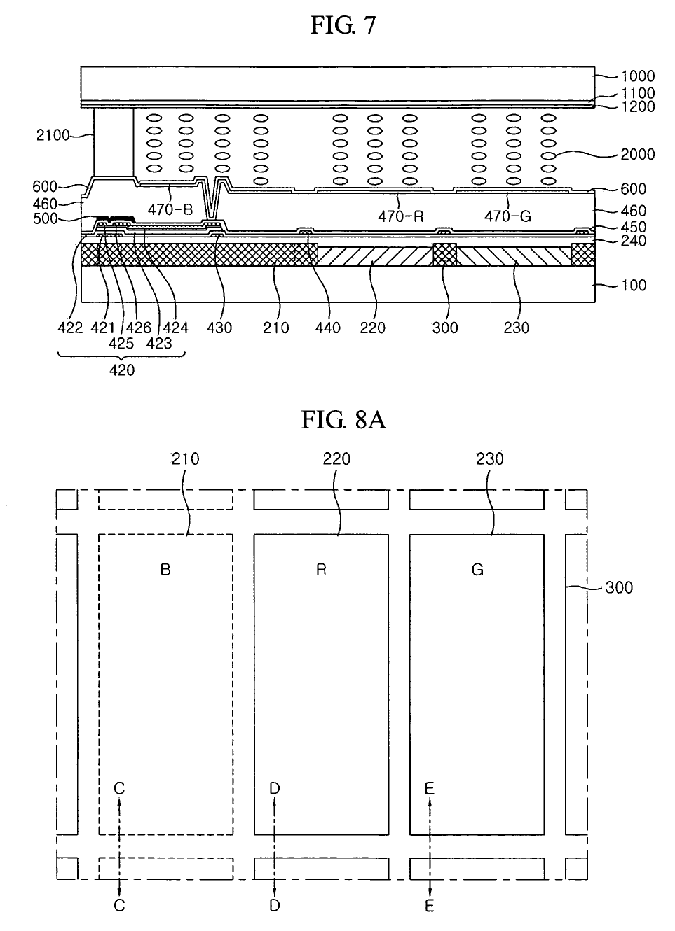

Referring to FIG. 7, a transparent common electrode 1100 and a second alignment layer 1200 are sequentially formed on an upper substrate 1000. As such, since only the common electrode 1100, i.e., a transparent conductive layer, is formed on the upper substrate 1000 in this exemplary embodiment, the process of manufacturing the upper substrate 1000 can be simplified. That is, the common electrode 1100 is deposited on the upper substrate 1000, and only the second alignment layer 1200 is formed on the common electrode 1100, so as to manufacture a common electrode substrate which is positioned in an upper portion of the display panel.

Column spacers 2100 are interposed between the lower substrate 100 and the upper substrate 1000 to maintain a cell gap between the two substrates. As described above, the lower substrate is provided with the blue, red and green color filters 210, 220 and 230, the TFTs and the pixel electrodes 470. And the upper substrate 1000 is provided with the common electrode 1100. In a state where a constant cell gap is maintained between the two substrates by the column spacers 2100, both substrates are bonded to each other. Subsequently, a liquid crystal material is injected between the two substrates using a vacuum injection method to form a liquid crystal layer 2000. Accordingly, the display panel is manufactured. Of course, the present invention is not limited thereto. That is, the column spacers 2100 are formed on the lower or upper substrate 100 or 1000, and a liquid crystal material is dropped on a surface of the lower or upper substrate 100 or 1000. Then, the lower and upper substrates 100 and 1000 are bonded and sealed to manufacture the display panel.

Of course, the present invention is not limited thereto. That is, the first light shielding pattern 300, the blue, red and green color filters 210, 220 and 230, and the overcoat layer 240 may be formed on the upper substrate 1000. In other words, the first light shielding pattern 300 and the blue color filter 210 are formed on the upper substrate 1000 using a blue photoresist layer. Subsequently, red and green color filters 220 and 230 are respectively formed in light transmitting regions of red and green pixels, which are defined by the first light shielding pattern 300. Then, an overcoat layer 240 is formed thereon, and a transparent common electrode 1100 and a second alignment layer 1200 are sequentially formed on the overcoat layer 240. Here, the first light shielding pattern 300, the blue, red and green color filters 210, 220 and 230, and the overcoat layer 240 are formed using the same method as described above. Further, the present invention is not limited thereto. That is, the second light shielding pattern 500 may be formed on the overcoat layer 240.

In addition, the present invention is not limited thereto. That is, light shielding columns for performing light shielding and cell gap maintaining are formed, so that the manufacturing process of the display panel, i.e., manufacturing process of the lower substrate, can be simplified. Hereinafter, a method for manufacturing a display panel according to another exemplary embodiment of the present invention is described with reference to the accompanying drawings. Some descriptions of the exemplary embodiment overlapping with those of the aforementioned exemplary embodiment will be omitted herein. Further, the descriptions of this exemplary embodiment are also applicable to the aforementioned descriptions.

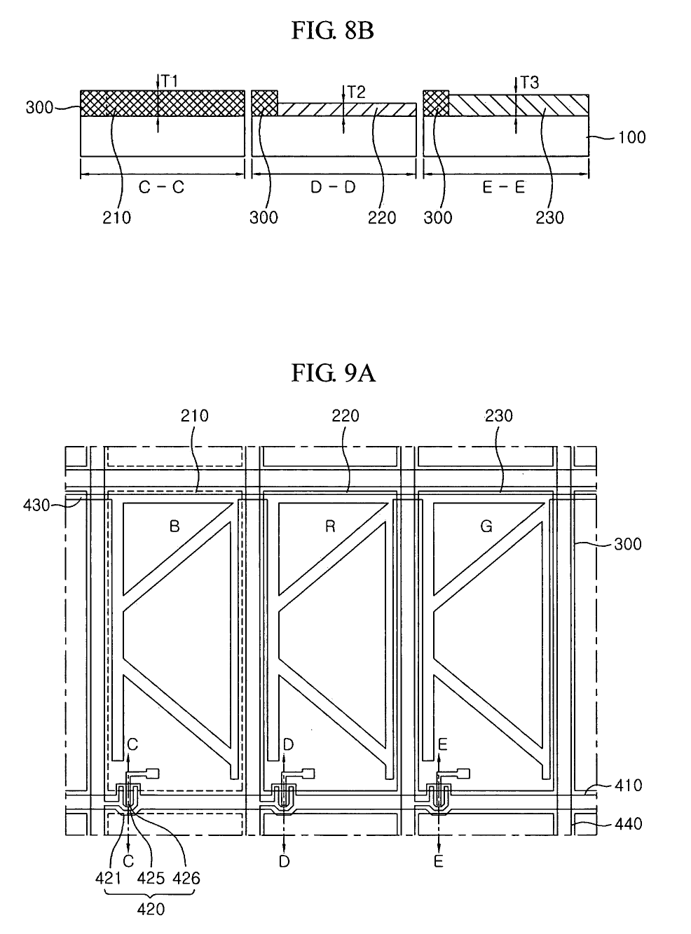

FIGS. 8A to 11A are plan views illustrating a method for manufacturing a display panel according to another exemplary embodiment of the present invention, and FIGS. 8B to 11B are sectional views illustrating the method for manufacturing a display panel according to the exemplary embodiment of the present invention.

Referring to FIGS. 8A and 8B, a lower substrate 100 is coated with a blue photoresist layer. The blue photoresist layer is exposed and developed using a mask, and thereby a blue color filter 210 and a first light shielding pattern 300 are formed.

Subsequently, red and green color filters 220 and 230 are formed in light transmitting regions of red and green pixels, which are defined by the first light shielding pattern 300, by an inkjet printing method, respectively.

In this embodiment, the first light shielding pattern 300 functions as a barrier for preventing the red and green color filters 220 and 230, which are formed by the inkjet printing method, from being out of the corresponding regions. That is, defects caused by overflow or mixture of inks (solutions for color filters) during an inkjet printing process can be minimized by means of the first light shielding pattern 300. Hence, thickness T1 of the first light shielding pattern 300, i.e., thickness T1 of the blue color filter 210, is formed to be the highest. In this exemplary embodiment, thickness T2 of the red color filter 220 may be formed to be lowest. The thickness can be controlled by adjusting the injection amount of a red color filter solution injected by the inkjet printing method.

That is, in this exemplary embodiment, the thickness T1 of the blue color filter 210 is highest, thickness T3 of the green color filter 230 is second highest, and the thickness T2 of the red color filter 220 is lowest. In the display panel manufactured through subsequent processes, the cell gap of the blue pixel is smallest, the cell gap of the green pixel is second smallest, and the cell gap of the red pixel is largest. Here, the cell gap means a gap (i.e., a spacing distance) between a pixel electrode and a common electrode. As such, the cell gaps of the blue, red and green pixels are different from one another, whereby a color shift, which induces change of the color of the display panel when viewed from sides thereof, can be suppressed. In particular, the color shift is excessive more severe in a vertical alignment (VA) mode in which liquid crystals in a display panel are vertically aligned with respect to a substrate. However, as described in this exemplary embodiment, since the thicknesses of the blue, red and green color filters 210, 220 and 230, that are respectively formed in the corresponding pixel regions, are different from one another, the color shift can be suppressed.

The thickness T1 of the blue color filter 210 may be formed to be higher than the thickness T3 of the green color filter 230 by 750 to 1250 Å. The thickness T2 of the red color filter 220 may be formed to be lower than the thickness T3 of the green color filter 230 by 750 to 1250 Å. Such a thickness difference may be adjusted depending on the mode and inherent light transmittance of liquid crystals. However, it may be difficult to prevent the color shift when the thickness difference is out of the aforementioned range.

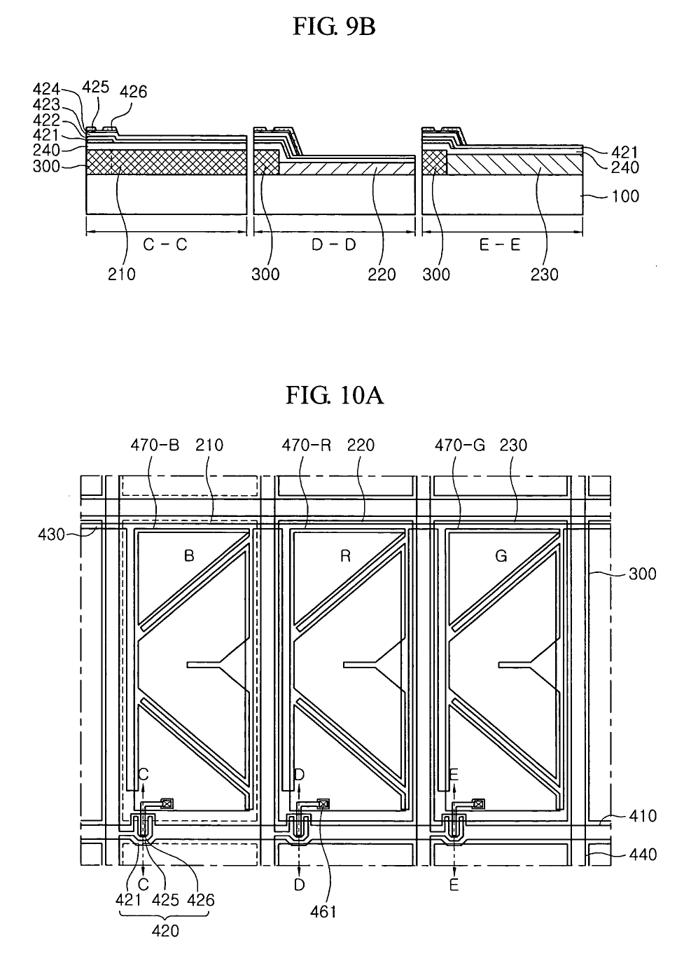

Referring to FIGS. 9A and 9B, an overcoat layer 240 is formed on an entire surface of the lower substrate 100 which is formed with the blue, red and green color filters 210, 220 and 230 having different thicknesses from one another and the first light shielding pattern 300.

Subsequently, gate lines 410, gate electrodes 421 and storage lines 430 are formed on the overcoat layer 240. As shown in FIG. 9A, the storage line 430 in this exemplary embodiment includes an extension line and a protrusion line. The extension line extends in the same direction as the gate line 410 and the protrusion line protrudes toward the light transmitting region of each pixel. The protrusion line may partially overlap with a cut-away pattern of a pixel electrode formed through a subsequent process.

Thereafter, a gate insulating layer 422 is formed on the entire surface of the lower substrate 100. An active layer 423 and an ohmic contact layer 424 are sequentially formed on the gate insulating layer 422. Data lines 440, source and drain electrodes 425 and 426 are formed on the ohmic contact layer 424. Accordingly, TFTs 420 are manufactured. At this time, the active layer 423 and the ohmic contact layer 424 may be formed only between the gate insulating layer 422 and the source and drain electrodes 425 and 426.

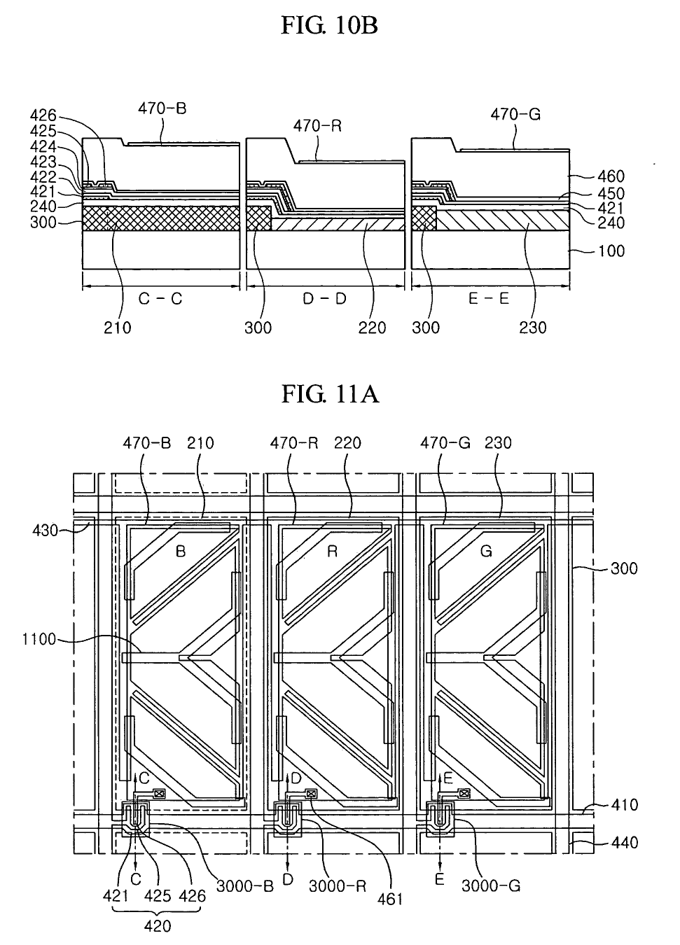

Referring to FIGS. 10A and 10B, a passivation layer 450 and a protective layer 460 are sequentially formed on the entire surface of the lower substrate 100 which is formed with the TFTs 420. Subsequently, the passivation layer 450 and the protective layer 460 are partially removed, thereby forming contact holes 461 for exposing portions of the drain electrodes 426. Then, pixel electrodes 470 (470-B, 470-R and 470-G) are formed on the protective layer 460. The pixel electrodes 470 (470-B, 470-R and 470-G) are respectively connected to the drain electrodes 426 through the contact holes 461. The pixel electrodes 470 are provided in the light transmitting regions of the blue, red and green pixels, respectively. At this time, each pixel electrode 470 has a cut-away pattern for domain division as shown in FIG. 10A. The cut-away pattern is not limited to the drawing shown in FIG. 10A in this exemplary embodiment but may vary. In FIG. 10A, the pixel electrodes 470 in one pixel region are connected to each other. However, the present invention is not limited thereto. That is, the pixel electrodes 470 in the one pixel electrode may be divided into a plurality of sub-pixel electrodes electrically isolated from one another. The respective sub-pixel electrodes may be connected to TFTs isolated from one another.

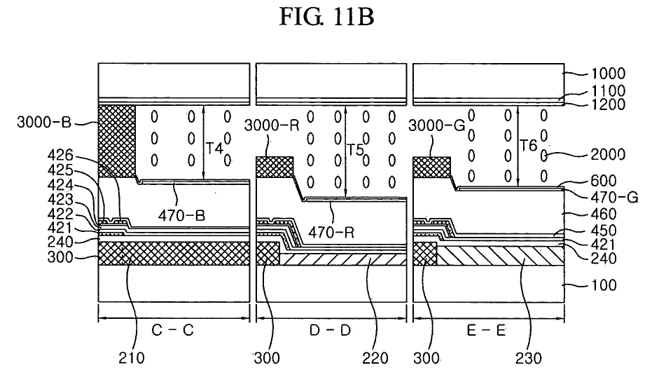

Referring to FIGS. 11A and 11B, light shielding columns 3000 (3000-B, 3000-R and 3000-G) are formed on the protective layer 460 in the regions above the TFTs 420. That is, the protective layer 460 having the pixel electrodes 470 formed thereon is coated with a light shielding material for a spacer. Subsequently, exposure thereof is performed using a mask. The exposed layer of a spacer material is removed through the development process, and then light shielding columns 3000 are formed on the protective layer 460 in the regions above the TFTs 420. Here, the light shielding column 3000 is formed of an organic material having light transmittance of 10% or less, so that light leakage through the TFT 420 can be prevented. Further, the light shielding column 3000 also functions as the column spacer 2100 in the previous exemplary embodiment. That is, the light shielding columns 3000 allow the cell gap between the lower and upper substrates to be maintained.

At this time, the light shielding columns 3000 are formed in the regions above the TFTs 420 in the display panel. Hence, the density of the light shielding columns 3000 functioning as column spacers is increased. In this exemplary embodiment, the density of the light shielding columns 3000 that function as column spacers can be lowered by lowering the thicknesses of the light shielding columns 3000-R and 3000-G that are respectively provided in the red and green pixel regions as shown in FIG. 11B. That is, only the light shielding columns 3000-B provided in the regions above the TFTs 420 connected to the blue pixel electrodes 470-B have a light shielding function for preventing light leakage and a column spacer function for maintaining a cell gap. The light shielding columns 3000-R and 3000-G respectively formed in the regions above the TFTs 420 connected to the red and green pixel electrodes 470-R and 470-G have only the light shielding function for preventing light leakage.

To this end, an exposure process using a slit mask may be performed when forming the light shielding columns 3000 to thereby provide a thickness difference between the light shielding columns 3000. It will be apparent that a half-tone mask may be used instead of the slit mask. The thickness of the blue light shielding columns 3000-B (the light shielding columns formed in the regions above the TFTs 420 connected to the blue pixel electrodes 470-B) may be higher than those of the red and green light shielding columns 3000-R and 3000-G (the light shielding columns respectively formed in the regions above the TFTs 420 connected to the red and green pixel electrodes 470-R and 470-G). At this time, the thicknesses of the red and green light shielding columns 3000-R and 3000-G may be the same. Of course, the present invention is not limited thereto. That is, the thicknesses of the red and green light shielding columns 3000-R and 3000-G may be different from each other.

Although not shown in this exemplary embodiment, a light shielding layer may be simultaneously formed in a peripheral area of the lower substrate 100 when the light shielding columns 3000 are formed. At this time, the light shielding layer may be formed to have the same thickness as the light shielding columns 3000 or to have a lower thickness than the light shielding columns 3000 using the aforementioned slit mask.

As such, in this exemplary embodiment, the light shielding columns having the light shielding function for preventing light leakage and the function of a column spacer for maintaining a cell gap are formed in the regions above the TFTs 420, so that the processes of forming light shielding columns and column spacers are integrated. Accordingly, the process of manufacturing the display panel can be more simplified.

Subsequently, a first alignment layer 600 is formed on top of the protective layer 460 which is formed with the pixel electrodes 470.

A common electrode 1100 is formed on an upper substrate 1000. At this time, a cut-away pattern for domain division is formed in the common electrode 1100. Then, a second alignment layer 1200 is formed on the common electrode 1100.

Thereafter, the lower and upper substrates 100 and 1000 are bonded and sealed together such that the pixel electrodes 470 of the lower substrate 100 and the common electrode 1100 of the upper substrate 1000 face each other, thereby manufacturing the display panel.

As shown in FIG. 11B, a spacing distance T4 between the pixel electrode 470-B in the blue pixel region and the common electrode 1100, i.e., the cell gap, may be closest, and a spacing distance T5 between the pixel electrode 470-R in the red pixel region and the common electrode 1100 may be farthest. This is caused by the aforementioned thickness difference between the blue, red and green color filters 210, 220 and 230. Thus, the spacing distance T4 between the pixel electrode 470-B in the blue pixel region and the common electrode 1100 may be closer by 750 to 1250 Å than a spacing distance T6 between the pixel electrode 470-G in the green pixel region and the common electrode 1100. The spacing distance T5 between the pixel electrode 470-R in the red pixel region and the common electrode 1100 may be farther by 750 to 1250 Å than the spacing distance T6 between the pixel electrode 470-G in the green pixel region and the common electrode 1100. Accordingly, a color shift in the display panel can be suppressed.

Of course, the present invention is not limited thereto. That is, the first light shielding patterns 300, and the blue, red and green color filters 210, 220 and 230 having different thicknesses from one another may be formed on the upper substrate 1000. The light shielding columns 3000 may also be formed on the upper substrate 1000. That is, the light shielding columns 3000 may be formed in the regions of the upper substrate 1000 corresponding to the TFTs 420. At this time, the light shielding columns 3000 may have different thicknesses as described above. The transparent common electrode 1100 may have a cut-away or protrusion pattern for domain division.

As described above, according to the exemplary embodiments of the present invention, a TFT array having color filters and TFTs is formed on a single substrate, so that the process of manufacturing a display panel can be simplified and a sufficient process margin can be ensured.

Further, in the exemplary embodiments of the present invention, a light shielding pattern is formed using a blue photoresist layer, whereby light leakage between adjacent pixel regions can be prevented, the mixture of colors between color filters can be prevented, and the process can be simplified.

Furthermore, according to the exemplary embodiments of the present invention, light shielding columns having the light shielding and cell gap maintaining functions are formed, whereby the process of forming the light shielding pattern for preventing light leakage can be omitted, which makes it possible to simplify the process.

In addition, according to the exemplary embodiments of the present invention, the productivity of a display panel can be enhanced through such process simplification, and the manufacturing costs of a display panel can also be reduced.

Although the present invention has been described in connection with the accompanying drawings and the preferred embodiment, the present invention is not limited thereto but defined by the appended claims. Accordingly, it will be understood by those skilled in the art that various modifications and changes can be made thereto without departing from the spirit and scope of the invention defined by the appended claims.

What is claimed is:

1. A method for manufacturing a display panel, comprising:
forming a first light shielding pattern in a boundary region of first to third pixel regions on a substrate using a photoresist layer of which light transmittance is 10 to 15% and a first color filter in the first pixel region;
forming second and third color filters in the second and third pixel regions, respectively;
forming a plurality of gate and data lines on the first light shielding pattern, and a plurality of thin film transistors (TFTs) respectively connected to the gate and data lines;
forming a protective layer on an entire structure of the substrate; and
forming pixel electrodes connected to the corresponding TFTs on the protective layer of the first to third pixel regions, respectively.

2. The method as claimed in claim 1, wherein the first color filter is a blue color filter, the second color filter is a red color filter and the third color filter is a green color filter.

3. The method as claimed in claim 2, wherein a thickness of the blue color filter is greater than a thickness of the green color filter, and the thickness of the green color filter is greater than a thickness of the red color filter.

4. The method as claimed in claim 3, wherein the thickness of the blue color filter is greater by 750 to 1250 Å than that of the green color filter, and the thickness of the red color filter is lower by 750 to 1250 Å than that of the green color filter.

5. The method as claimed in claim 2, wherein forming the first light shielding pattern and the first color filter comprises
coating the substrate with a blue photoresist layer;
exposing the blue photoresist layer using a mask; and
developing an exposed region of the blue photoresist layer, and removing the blue photoresist layer in the red and green pixel regions,
and wherein the red and green color filters are formed by an inkjet printing method.

6. The method as claimed in claim 5, wherein the line width of the first light shielding pattern is 101% to 130% of that of the gate and/or data line.

7. The method as claimed in claim 5, after forming the plurality of TFTs, further comprising forming a second light shielding pattern on top of the plurality of TFTs.

8. The method as claimed in claim 5, after forming the plurality of TFTs, further comprising:
forming a passivation layer on top of the entire structure of the substrate; and
forming a second light shielding pattern on the passivation layer in regions above the plurality of TFTs.

9. The method as claimed in claim 7, wherein the second light shielding pattern is also formed in a peripheral area of the substrate.

10. The method as claimed in claim 1, after forming the pixel electrodes, further comprising forming light shielding columns in regions above the plurality of TFTs.

11. The method as claimed in claim 10, wherein the light shielding columns are further formed in a peripheral area of the substrate.

12. The method as claimed in claim 10, wherein forming the light shielding columns comprises:
coating the entire structure of the substrate with a non-transparent organic layer; and
exposing and developing the non-transparent organic layer using a slit mask or a half-tone mask, and removing the non-transparent organic layer of a region except the regions above the plurality of TFTs.

13. A method for manufacturing a display panel, comprising:
forming a first light shielding pattern in a boundary region of blue, red and green pixel regions on an upper substrate using a blue photoresist layer, and a blue color filter in the blue pixel region;
forming red and green color filters in red and green pixel regions, respectively; and
forming a common electrode on top of the upper substrate having the color filters formed thereon.

14. The method as claimed in claim 13, wherein the first light shielding pattern and the blue color filter are formed through an exposure and development process using the blue photoresist layer, and the red and green color filters are formed by an inkjet printing method.

15. The method as claimed in claim 13, wherein a thickness of the blue color filter is greater than a thickness of the green color filter, and a thickness of the green color filter is greater than a thickness of the red color filter.

16. The method as claimed in claim 13, further comprising:
providing a lower substrate having TFTs, gate lines, data lines and pixel electrodes formed thereon; and
bonding and sealing the upper substrate having the common electrode formed thereon and the lower substrate,
wherein the line width of the first light shielding pattern is 101% to 130% of that of the gate and/or data line.

17. The method as claimed in claim 16, further comprising forming a second light shielding pattern on a region of the upper substrate corresponding to the TFTs before forming the common electrode.

18. The method as claimed in claim 16, further comprising forming light shielding columns on a region of the upper substrate corresponding to the TFTs after forming the common electrode.

19. A display panel, comprising:
a lower substrate having a plurality of blue, red and green pixel regions defined therein;
a first light shielding pattern formed in a boundary region of the plurality of blue, red and green pixel regions on the lower substrate using a blue photoresist layer;
a plurality of blue color filters formed in the plurality of blue pixel regions;
a plurality of red and green color filters formed in the plurality of red and green pixel regions, respectively;
a plurality of gate and data lines formed on the first light shielding pattern;
a plurality of TFTs connected to the plurality of gate and data lines, respectively;
a plurality of pixel electrodes formed in the plurality of blue, red and green pixel regions and connected to the corresponding TFTs, respectively;
an upper substrate having a common electrode, the upper substrate being spaced apart from the lower substrate so that the common electrode faces the pixel electrodes; and
a liquid crystal layer interposed between the upper and lower substrates.

20. The display panel as claimed in claim 19, wherein the blue color filter and the first light shielding pattern are continuously formed,
wherein a thickness of the blue color filter is greater than a thickness of the green color filter, and a thickness of the green color filter is greater than a thickness of the red color filter.

21. The method as claimed in claim 20, wherein the thickness of the blue color filter is greater by 750 to 1250 Å than that of the green color filter, and the thickness of the red color filter is lower by 750 to 1250 Å than that of the green color filter.

22. The display panel as claimed in claim 19, wherein a line width of the first light shielding pattern is 101% to 130% of that of the gate and/or data line.

23. The display panel as claimed in claim 19, further comprising a second light shielding pattern formed on the plurality of the TFTs.

24. The display panel as claimed in claim 19, further comprising light shielding columns formed between the lower and upper substrates.

25. The display panel as claimed in claim 24, wherein the light shielding columns are formed of an organic material with light transmittance of 10% or less and formed on the plurality of the TFTs.
